(19) United States
(12) Patent Application Publication
(10) Pub. No.: US 2010/0125597 A1
(43) Pub. Date: May 20, 2010

(54) SYSTEM AND METHOD FOR DETERMINING SEARCH TERMS FOR USE IN SPONSORED SEARCHES

(75) Inventor: Amit Umesh Shanbhag, San Francisco, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/271,494

(22) Filed: Nov. 14, 2008

(51) Int. Cl. G06F 17/30; G06F 7/00

(52) U.S. Cl. 707/765; 707/E17.108

(57) ABSTRACT

Systems and methods for determining search terms for sponsored Internet searches are disclosed. A digital Internet ad is served to a plurality of Internet users. Search terms used by the plurality of Internet users served the digital Internet ad may be determined. A number of times each of the plurality of Internet users served the digital Internet ad selects the digital Internet ad is determined. A search term recommendation module determines a correlation level between each search term and the digital Internet ad. At least one of the search terms is recommended for a sponsored Internet search based on the determined correlation levels.

### BACKGROUND

Internet advertising may implement the use of graphical ad campaigns. The graphical ad campaigns may be categorized into brand advertising campaigns and direct marketing campaigns. In brand advertising campaigns, brand advertisers may be interested in generating brand awareness. A strategy may be to present a brand through graphical ads to as many individuals as possible in hopes of increasing the brand popularity. In direct marketing campaigns, advertisers may be concerned with individuals responding directly to an Internet ad, such as by clicking on a universal resource locator (“URL”), allowing an individual to immediately purchase goods or services through selection of a graphical ad.

Brand advertisers may not be interested in participating in direct marketing campaigns, which may include sponsored Internet searches, allowing graphical ads to be delivered to a user based on particular search terms provided to an Internet search engine by an Internet user. The brand advertiser may believe that sponsored searches generating Internet search listings may not increase popularity associated with a particular brand. However, a brand advertiser may be interested in participating in a sponsored search if the brand advertiser believed specific search terms may be relevant to a particular brand.

### BRIEF DESCRIPTION OF THE DRAWINGS

FIG. 1 is a block diagram of one example of an environment in which a system for determining search terms for a sponsored search;

FIG. 2 is a block diagram of one embodiment of a system for determining search terms for a sponsored search;

FIG. 3 is a block diagram of one example of a search term recommendation module;

FIG. 4 is a flow chart of one embodiment of a method for recommending search terms for a sponsored search; and

FIG. 5 is a block diagram of one embodiment of a computer system.

### DETAILED DESCRIPTION OF THE DRAWINGS

The present disclosure is directed to systems and methods for determining recommended search terms for a sponsored search. An online advertisement service provider (“ad provider”) may desire to determine search terms for a sponsored search based on Internet user interest in a digital Internet ad. A search term recommendation module may record search terms used by Internet users served the digital Internet ad. The search term recommendation module may determine a correlation between subject matter of the digital Internet ad and search terms used by the Internet users served the digital Internet ad. The correlation may be used to recommend search terms to an advertiser for sponsored searches concerning subject matter of the digital Internet ad.

The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may pay additional premiums for certain targeting options, such as targeting by demographics, geography, technographics or context. The digital ad may be a graphical banner ad that appears on a website viewed by Internet users 112, a sponsored search listing that is served to an Internet user 112 in response to a search performed at a search engine, a video ad, a graphical banner ad based on a sponsored search listing, and/or any other type of online marketing media known in the art.

When an Internet user 112 performs a search at a search engine 108, the search engine 108 may return a plurality of search listings to the Internet user. The ad provider 106 may additionally serve one or more digital ads to the Internet user 112 based on search terms provided by the Internet user 112. In addition or alternatively, when an Internet user 112 views a website served by the website provider 110, the ad provider 106 may serve one or more digital ads to the Internet user 112 based on keywords obtained from the content of the website.

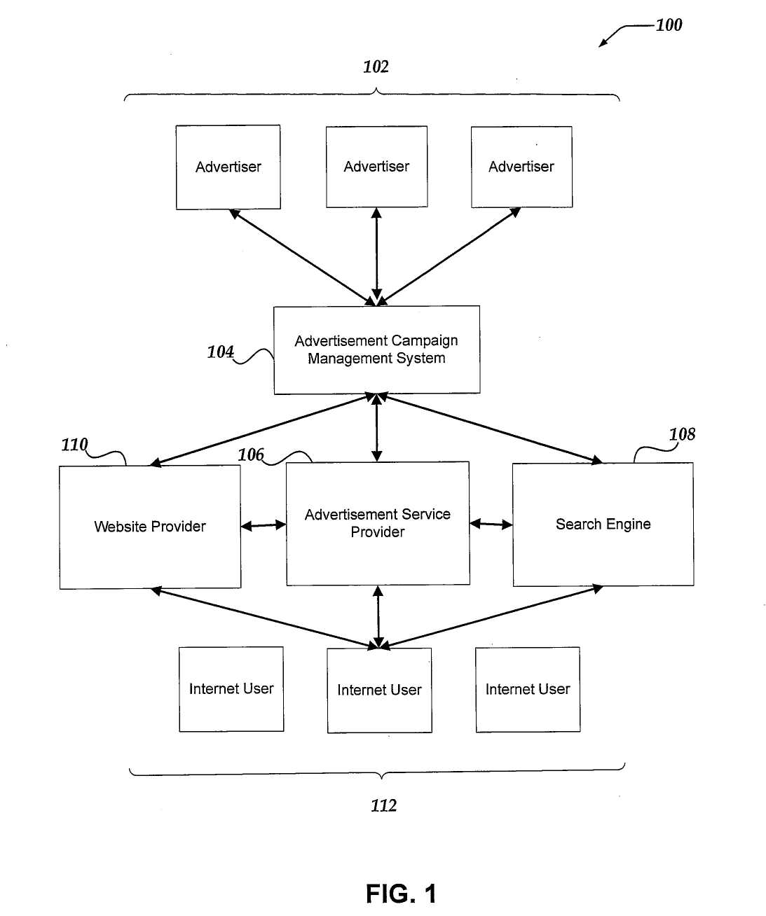

When the search listings and digital ads are served, the ad campaign management system 104, the ad provider 106, and/or the search engine 108 may record and process information associated with the served search listings and digital ads for purposes such as billing, reporting, or ad campaign optimization. For example, the ad campaign management system 104, ad provider 106, and/or search engine 108 may record the search terms that caused the search engine 108 to serve the search listings; the search terms that caused the ad provider 106 to serve the digital ads; whether the Internet user 112 clicked on a URL associated with one of the search listings or digital ads; what additional search listings or digital ads were served with each search listing or each digital ad; a rank of a search listing when the Internet user 112 clicked on the search listing; a rank or position of a digital ad when the Internet user 112 clicked on a digital ad; and/or whether the Internet user 112 clicked on a different search listing or digital ad when a digital ad, or a search listing, was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference. It will be appreciated that the systems and methods for determining search terms described below may operate in the environment of FIG. 1.

In the environment 100, some types of advertisers, such as brand advertisers may not be interested in digital ads being delivered based on a sponsored search. Instead, the brand advertisers may be interested in purchasing digital ads based on the auction model of buying ad space or the guaranteed delivery model by which an advertiser pays a minimum cost-per-thousand impressions (i.e., CPM) to display the digital ad, as described above. However, a brand advertiser may be interested in delivering a digital ad based on a sponsored search if particular search terms were identified as having some correlation with an Internet user 112 identified as having an interest in the brand advertiser's particular brand or brands. The environment 100 may be configured to determine a correlation between a digital ad and search terms that may be more relevant for a sponsored search regarding the subject matter of the graphical ad.

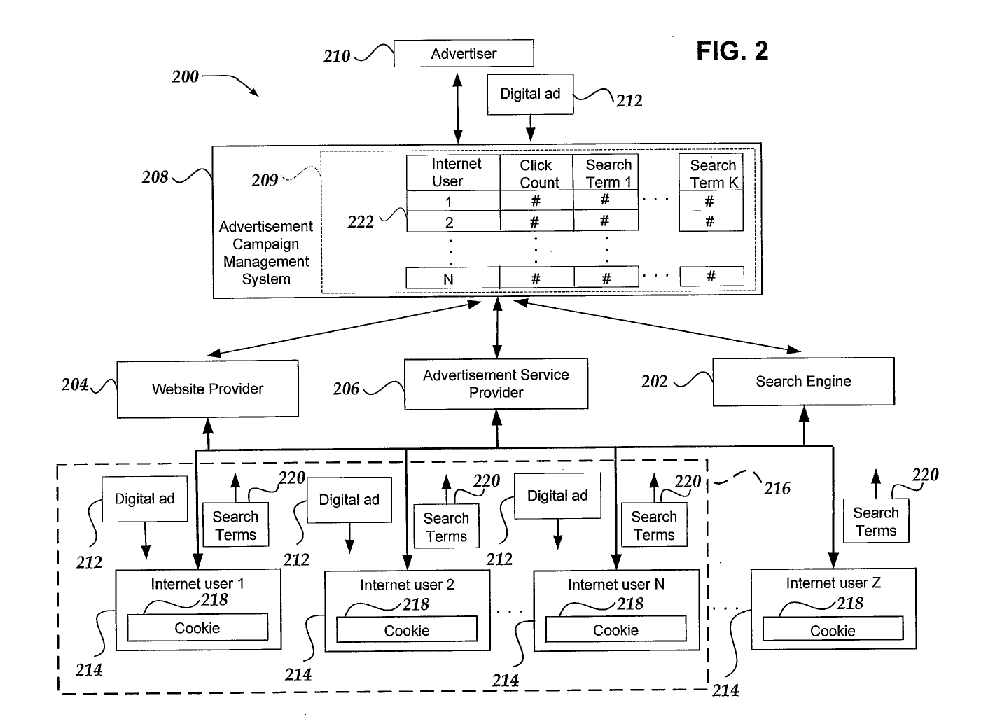

FIG. 2 is a block diagram of one embodiment of a system 200 for recommending search term to an advertiser for use in a sponsored search. The system 200 may include a search engine 202, a website provider 204, an ad provider 206, and an ad campaign management system 208. In some implementations, the ad campaign management system 208 may be part of the search engine 202, website provider 204, and/or ad provider 206. However, in other implementations, the ad campaign management system 208 is distinct from the search engine 202, website provider 204, and/or ad provider 206.

The search engine 202, website provider 204, ad provider 206, and ad campaign management system 208 may communicate with each other over one or more external or internal networks. The networks may include local area networks (LAN), wide area networks (WAN), and the Internet, and may be implemented with wireless or wired communication mediums such as wireless fidelity (WiFi), Bluetooth, landlines, satellites, and/or cellular communications. Further, the search engine 202, website provider 204, ad provider 206, ad campaign management system 208 may be implemented as software code running in conjunction with a processor such as a single server, a plurality of servers, or any other type of computing device known in the art.

As described in more detail below, an advertiser 210 may provide a digital ad 212 that may be provided to a plurality of Internet users 214. In FIG. 2, the digital ad 212 may be served to each of a plurality of Internet users 214 based on the auction model of buying ad space or the guaranteed delivery model to display the digital ad, as previously described. In one example, the digital ad 212 may be provided to the Internet users 214 through the website provider 204 and/or ad provider 206. In the example of FIG. 2, the system 200 may include a number Z different Internet users 214. Of these Z Internet users 214, a subset 216 of N Internet users 214 may be served with the digital ad 212.

A search term recommendation module 209 may identify the Internet users 214 served with the digital ad 212. In one example, the search term recommendation module 209 may be executed by ad campaign management system 208. In alternative examples, the search term recommendation module 209 may be executed by the ad provider 206 or other suitable system. In one example, each Internet user 214 may be identified by the search term recommendation module 209 through a respective cookie 218 allowing various Internet activities conducted by each Internet user 214 to be tracked. Such Internet activities may include performing Internet searches using various search terms 220. The search terms 220 may be one or more string of characters used as input to an Internet search through a search engine 202.

Internet activity of the subset 216 of Internet users 214 may be tracked and stored by the search term recommendation module 209 as indicated by table 222. In alternative examples, the website provider 204, the ad provider 206, or the search engine 202 may each be used to track and store the number of times each Internet user 214 performs an Internet search using a particular search term 220 and relay the information to the search term recommendation module 209. The particular search terms 220 are designated as search terms 1 through K in the table 222 for purposes of illustration. The number of times each Internet user 214 of the subset 216 selects, or clicks, on the digital ad 212 may also be stored by search term recommendation module 209 as indicated by the field “Click Count” in the table 222. In one example, the subset 216 of Internet users 214 may be predetermined so that, once N Internet users 214 have been served the digital ad 212, no other Internet users 214 are monitored even if served with the digital ad 212. In another example, the subset 216 may represent N Internet users 214 to have clicked on the digital ad 212. In another example, once the subset 216 of Internet users are selected, the Internet activity of each Internet user 214 in the subset 216 may be monitored and the search terms and click counts may be obtained over a predetermined amount of time.

The Internet activity associated with the subset 216 of the Internet users 214 may be processed to determine search terms that may be recommended to an advertiser associated with the digital ad 212 and/or used in a sponsored search. In one example, the search term recommendation module 209 may determine a correlation level between each search term 1 through K and the digital ad 212. This correlation level may vary search term by search term, which may indicate that particular ones of search terms 1 through K are more relevant to subject matter advertised through a digital ad 212. The search terms 1 through K having relatively higher correlation levels may be more desirable for an advertiser to bid upon for purposes of a sponsored search.

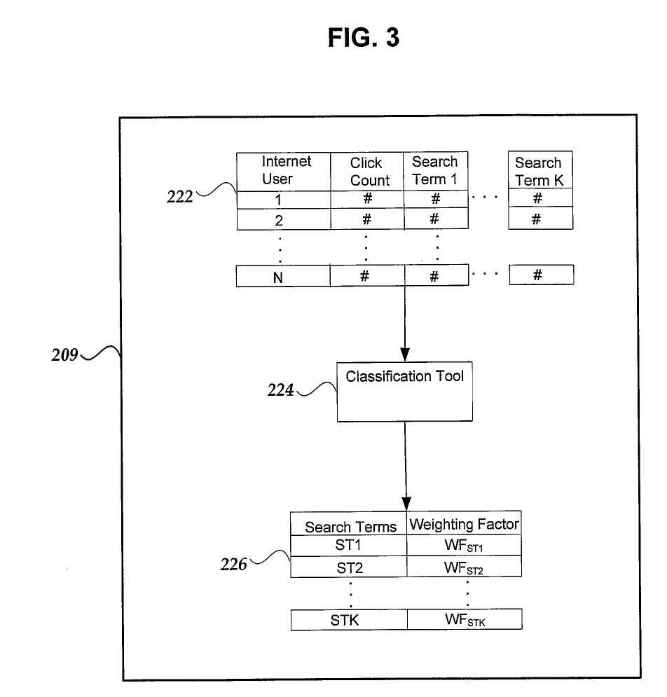

In one example, the search term recommendation module 209 may use the information in the table 222 to determine the correspondence level between each search term 220 and the digital ad 212. FIG. 3 depicts an example of the search term recommendation module 209 configured to determine a correlation level between each search term 1 through K and the digital ad 212 in the form of a corresponding weighting factor. The search term recommendation module 209 may utilize the data obtained based on the Internet user activity as summarized in table 222, which includes the click count for each Internet user 214 of the subset 216 and a number of times each search term 1 through K is used for an Internet search by each of the Internet users 214 of the subset 216.

The search term recommendation module 209 may implement a classification tool 224, which may determine the weighting factor for each search term 1 through K. In one example, the classification tool may utilize a classification technique, such as a linear regression for example, in determining a weighting factor. In alternative examples, other classification techniques may be applied such as rule based, regression trees, neural networks, Bayesian networks, or other suitable technique, for example. The linear regression technique may be used to establish a relationship between the click counts and number of searches performed with each search term 1 through K. In one example, the relationship may be established through the following equation:

Y=XB+ε EQN. (1)

where Y is the click count for one of the Internet users 214 of the subset 216, X is an array of the numbers of Internet searches performed by an Internet user 214 of the subset 216 for each search term 1 through K; B is an array of weighting factors that represent the level of correspondence between each search term 1 through K and the click count; and ε represents an error factor.

The linear regression technique may be used for each Internet user 1 through N allowing the weighting factor B for each search term 1 through K to be determined. The weighting factor B may be a number between 0 and 1, with all of the weighting factors associated with each Internet user 214 summing to approximately 1. Upon determining the weighting factors for each search term 1 through K, the search terms 1 through K may be ranked according to weighting factor. The search term or terms having the highest weighting factor may have the highest rank. The search term or terms 1 through K having the rank, and thus, the relatively highest weighting factor(s), may be the search terms recommended to the advertiser 202 for use in a sponsored search. Table 226 illustrates the weighting factors, designated individually as WF_{ST1} through WF_{STK} in the table 226, corresponding to each search term 1 through K, designated as ST1 through STK in the table 226.

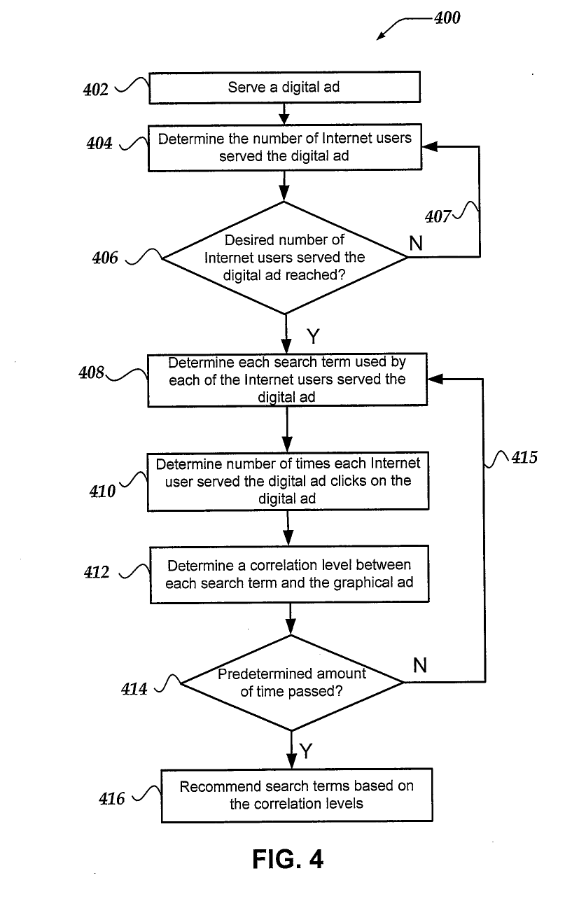

FIG. 4 depicts a method 400 of determining search terms to recommend to an advertiser for use in a sponsored search. The method 400 may include a step 402 of serving a digital ad. In one example, step 402 may include serving a digital ad to a number of Internet users. The digital ad may be served to an Internet user based on the auction model of buying ad space or a guaranteed delivery model to display the digital ad, for example. The method 400 may also include a step 404 of determining the number of Internet users served the digital ad. In one example, the step 404 may be performed through a system such as the system 200 shown in FIG. 2. The search term recommendation module 209 of the system 200 may track and store the number of Internet users 214 being served the ad based on a cookie 218 of each Internet user 214.

The method 400 may include a step 406 of determining if the desired number of Internet users to receive the digital ad has been reached. In one example, a predetermined number may be selected as a limit on the number of Internet users served the digital ad that are to be tracked. If the desired number has not been reached in step 406 then loop 407 may return the method 400 to step 404 to continue determining the number of Internet users to receive the digital ad. In one example, step 406 may continue to be performed while other steps of the method 400 are performed.

The method 400 may include a step 408 of determining each search term used by each of the Internet users served the digital ad. In one example, step 408 may be performed by tracking and storing search terms used by each Internet user that has been served with the digital ad. The method 400 may include a step 410 of determining a number of times each Internet user served with the digital ad clicks on the digital ad. Steps 408 and 410 may be performed with a system, such as the system 200 of FIG. 2. In one example, the steps 408 and 410 may be performed by the ad campaign management system 208.

The method 400 may include a step 412 of determining a correlation level between each search term and the digital ad. In one example, step 412 may include determining a correlation level between search terms and the digital ad by performing a classification technique on information regarding the number of times each Internet user has clicked on the digital ad and the search terms used by the Internet user, such as that described in regard to FIGS. 2 and 3, for example. The classification technique may provide weighting factors associated with each search term representing the correlation levels. A weighting factor associated with a particular search word may indicate the level of correlation between that particular search word and the digital ad.

The method 400 may include a step 414 of determining if a predetermined time has elapsed. In one example, the correspondence levels may continuously be updated until a predetermined time has elapsed, which then allows final correspondence values to be determined at step 414. If the predetermined time has not elapsed, loop 415 may return to step 408. Once the predetermined amount of time has elapsed, step 416 of the method 400 may be performed, which includes recommending search terms for sponsored searches based on the correlation levels. In one example, a search term having the highest correlation level may the most highly recommended term. As described in FIGS. 2 and 3, a search term 220 having the highest weighting factor as compared to the weighting factors of the other search terms 220 may have the highest rank among recommended search terms. Thus, the search term(s) with the highest rank (e.g., highest weighting factor) may be the first search term(s) recommended. The search term(s) with the next highest rank may be the next recommended search term, and so forth. This configuration allows search terms for to be recommended to an advertiser of the digital ad for purposes of becoming involved with a sponsored search based on subject matter in a digital ad.

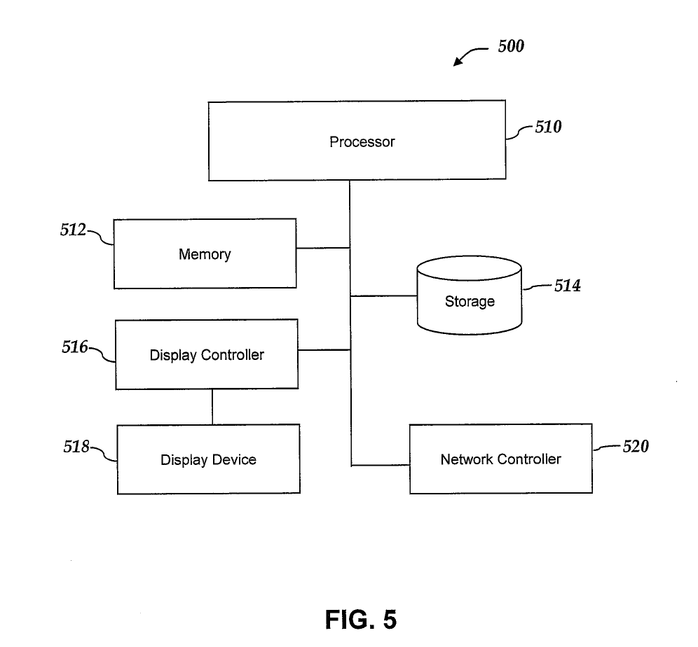

Any of the modules, servers, or engines described may be implemented in one or more general computer systems. One exemplary system is provided in FIG. 5. The computer system 500 includes a processor 510 for executing instructions such as those described in the methods discussed above. The instructions may be stored in a computer readable medium such as memory 512 or a storage device 514, for example a disk drive, CD, or DVD. The computer may include a display controller 516 responsive to instructions to generate a textual or graphical display on a display device 518, for example a computer monitor. In addition, the processor 510 may communicate with a network controller 520 to communicate data or instructions to other systems, for example other general computer systems. The network controller 520 may communicate over Ethernet or other known protocols to distribute processing or provide remote access to information over a variety of network topologies, including local area networks, wide area networks, the internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A method of determining search terms for a sponsored search, the method comprising:
serving a digital Internet ad to a plurality of Internet users;
determining a number of times each of the plurality of Internet users selects the digital Internet ad;
determining each search term used by each of the plurality of Internet users in performing an Internet search;
determining a number of times each search term is used by each of the plurality of Internet users to perform an Internet search;
determining a correlation level between each search term and the digital Internet ad based on the number of times each of the plurality of Internet users selects the digital Internet ad and the number of times each search term is used by each of the plurality of Internet users to perform an Internet search; and
determining at least one search term for a sponsored Internet search based on the correlation level associated with each search term.

2. The method of claim 1, wherein serving a digital Internet ad to a plurality of Internet users comprises serving the digital Internet ad to a predetermined number of Internet users.

3. The method of claim 1, wherein determining each search term used by each of the plurality of Internet users in performing an Internet search comprises determining each search term used by each of the plurality of Internet users in performing an Internet search over a predetermined amount of time.

4. The method of claim 3, wherein determining a number of times each search term is used by each of the plurality Internet users to perform an Internet search comprises determining the number of times each search term is used by each of the plurality Internet users to perform an Internet search over the predetermined amount of time.

5. The method of claim 3, wherein determining a correlation level between each search term and the digital Internet ad comprises determining a weighting factor associated with each search term based on the number of times each of the plurality of Internet users select the digital Internet ad and the number of times each search term is used by each of the plurality of Internet users to perform an Internet search; and
wherein, determining at least one search term for a sponsored Internet search comprises selecting a search term having a highest weighting factor for use in the sponsored Internet search.

6. A computer-readable storage medium comprising a set of instructions for determining search terms for use in a sponsored search, the set of instructions to direct a processor to perform acts of:
serving a digital Internet ad to a plurality of Internet users;
determining a number of times each of the plurality of Internet users selects the digital Internet ad;
determining each search term used by each of the plurality of Internet users in performing an Internet search;
determining a number of times each search term is used by each of the plurality of Internet users to perform an Internet search;
determining a rank associated with each search term based on the number of times each of the plurality of Internet users selects the digital Internet ad and the number of times each search term is used by each of the plurality of Internet users to perform an Internet search; and
determining at least one search term for a sponsored Internet search based the rank associated with each search term.

7. The computer readable medium of claim 6, wherein determining at least one search term comprises selecting a search term having a highest rank as the search term for the sponsored Internet search.

8. The computer readable medium of claim 6, wherein determining a rank associated with each search term comprises determining a correlation level between each search term and the digital Internet ad based on the number of times each of the plurality of Internet users select the digital Internet ad and the number of times each search term is used by each of the plurality of Internet users to perform an Internet search.

9. The computer readable medium of claim 8, wherein determining at least one search term comprises determining at least one search term for a sponsored Internet search based on the correlation level associated with each search term.

10. The computer readable medium of claim 6, wherein serving a digital Internet ad to a plurality of Internet users comprises serving the digital Internet ad to a predetermined number of Internet users.

11. The computer readable medium of claim 6, wherein determining each search term used by each of the plurality of Internet users in performing an Internet search comprises determining each search term used by each of the plurality of Internet users in performing an Internet search over a predetermined amount of time.

12. The computer readable medium of claim 11, wherein determining a number of times each search term is used by each of the plurality Internet users to perform an Internet search comprises determining the number of times each search term is used by each of the plurality Internet users to perform an Internet search over the predetermined amount of time.

13. The computer readable medium of claim 6, wherein determining a rank associated with each search term comprises determining a weighting factor associated with each search term based on the number of times each of the plurality of Internet users select the digital Internet ad and the number of times each search term is used by each of the plurality of Internet users to perform an Internet search; and
wherein, determining at least one search term for a sponsored Internet search comprises selecting a search term having a highest weighting factor for use in the sponsored Internet search.

14. A system for determining search terms for sponsored search, the system comprising:
a processor configured to execute a search term recommendation module, wherein the search term recommendation module, when executed, is configured to:
identify a plurality of Internet users served a digital Internet ad;
determine a number of times each of the plurality of Internet users selects the digital Internet ad;
determine each search term used by each of the plurality of Internet users in performing an Internet search;
monitor Internet activity of each of the plurality of users;
determine a correlation level between each search term and the digital Internet ad based on the number of times each of the plurality of Internet users select the digital Internet ad and the Internet activity of each of the plurality of Internet users; and
determine at least one search term for a sponsored Internet search based on the correlation level associated with each search term.

15. The system of claim 14, wherein the search term recommendation module, when executed by the processor, is further configured to:
determine a number of times each search term is used by each of the plurality of Internet users to perform an Internet; and
determine a correlation level between each search term and the digital Internet ad based on the number of times each of the plurality of Internet users select the digital Internet ad and the number of times each search term is used by each of the plurality of Internet users to perform an Internet search.

16. The system of claim 14, wherein the search term recommendation module, when executed by the processor, is further configured to serve the digital Internet ad to a predetermined number of Internet users.

17. The system of claim 14, wherein the search term recommendation module, when executed by the processor, is further configured to determine each search term used by each of the plurality of Internet users in performing an Internet search over a predetermined amount of time.

18. The system of claim 17, wherein the search term recommendation module, when executed by the processor, is further configured to determine the number of times each search term is used by each of the plurality Internet users to perform an Internet search over the predetermined amount of time.

19. The system of claim 14, wherein the search term recommendation module, when executed by the processor, is further configured to:
determine a weighting factor associated with each search term based on the number of times each of the plurality of Internet users select the digital Internet ad and the number of times each search term is used by each of the plurality of Internet users to perform an Internet search; and
determine at least one search term for a sponsored Internet search comprises selecting a search term having a highest weighting factor for use in the sponsored Internet search.
